(19) United States
(12) Patent Application Publication
(10) Pub. No.: US 2009/0214722 A1
(43) Pub. Date: Aug. 27, 2009

(54) FOOD CASING WITH BARRIER ACTION FOR OXYGEN AND/OR WATER VAPOR AND SUITABLE FOR ABSORBING AND STORING A FOOD ADDITIVE AND RELEASING IT TO THE FOOD

(75) Inventors: Heinrich HENZE-WETHKAMP, Walsrode (DE); Jorg OBLOTZKI, Bad Salzuflen (DE); Anton KRALLMANN, Bad Fallingbostel (DE)

Correspondence Address: KNOBBE MARTENS OLSON & BEAR LLP, 2040 MAIN STREET, FOURTEENTH FLOOR, IRVINE, CA, 92614, US

(73) Assignee: CASETECH GMBH, BOMLITZ (DE)

(21) Appl. No.: 12/393,808

(22) Filed: Feb. 26, 2009

(30) Foreign Application Priority Data
Feb. 26, 2008 (EP) EP 08 003 420.0

(51) Int. Cl. A22C 13/00; A23L 1/226; B65D 81/34; A23P 1/12

(52) U.S. Cl. 426/105; 428/34.8; 426/534; 426/413; 426/514

(57) ABSTRACT

The present invention relates to a multilayer seamless tubular film as a food casing with barrier action for oxygen and/or water vapor, which is capable of absorbing and storing a food additive and releasing it to the food. It is used as an envelope of pasty or liquid materials and is particularly suitable as a synthetic sausage casing. The invention further relates to a particular liquid smoke composition which, in combination with such a tubular film, is particularly suitable for transferring the dyes and flavorings present to the food.

### FIELD OF THE INVENTION

The present invention relates to a multilayer seamless tubular film as a food casing with barrier action for oxygen and/or water vapor, which is capable of absorbing and storing a food additive and releasing it to the food. It is used as an envelope of pasty or liquid goods and is particularly suitable as a synthetic sausage skin, especially for the production of sausage, which is to absorb aromas and/or dyes without additional processing steps.

### DESCRIPTION OF THE RELATED ART

According to the material to be produced and to be packaged, a tubular casing must fulfill extensive specific properties in order to comply with the applications in practice. In sausage production, these may, for example, be high barrier properties against water vapor and oxygen, thermal stability up to sterilization temperature, defined adhesion to the filling, sufficient shrinkage, high mechanical strength, dimensional stability, tautness, good peeling behavior, good hot and cold slicing behavior, easy finishability, especially shirrability, good colorability and color coverage, good printability, transfer properties of dyes and aromas applied, reliable adhesion of printing ink, and safety according to food law (EC Guidelines, German Federal Institute for Risk Assessment (BfR), Food and Drug Administration FDA) and ecological safety of the materials used.

The smoking of foods in smoking chambers has been prior art for some time. As known from DE 3029028 A1, especially cellulose casing, cellulose fiber casing and collagen casings are employed owing to their high permeability values for smoke dye and smoke aroma. However, this smoking step is a complicated process associated with additional costs. Owing to the situation of rising costs, smokeable polymer casings in particular have been developed.

DE 10208858 A1 discloses a structure which, to increase the smoke and water vapor permeability, describes a mixture of a thermoplastic material with a polysaccharide component, a plasticizer, a glycol and/or polyglycol unit. The polysaccharide is preferably starch. However, this requires that there are no adjacent further barrier layers which suppress these transfer properties.

The prior art further discloses that, for the transfer of aromas and dyes, synthetic sausage casings can be impregnated externally and internally. External impregnation requires, however, a casing which has a sufficiently high permeability for the substances. The high permeability leads to weight losses owing to escaping water vapor and leads to graying as a result of oxygen entering. These disadvantages can be balanced out by multilayer polymer casings.

Seamless tubular casings composed of thermoplastic polymers are widespread on the market and are notable for their good barrier properties. Savic, Z.: Sausage Casings, VICTUS Lebensmittelindustriebedarf, Vienna, Austria, p. 245-300 and Kohan, Melvin I.: Nylon Plastics Handbook, Carl Hanser Verlag, Munich Vienna New York, 1995, p. 151-190, disclose that, to produce such tubular casings, the blown film method or the double-bubble method can be used. These methods are also described in EP 0559084 B1.

DE 19846305 A1 describes a barrier casing is provided with an internal absorptive layer of a few hundredths to 1/10 mm. This layer can be impregnated with dyes and/or aromas in a further process step. The absorptive layer here is a fiber nonwoven which is joined to the cover film by means of an adhesive layer. After a drying step, the laminate can be shaped to a tube with double-sided adhesive tape or overlapping heat welding. Disadvantages of this structure are not only the high material consumption, but also the seal seam which weakens the peeling properties of the casing and additionally influences the mechanical strength of the casing.

For the impregnation, the internal sausage meat contact side must have sufficient absorptivity. The liquid should be completely drawn in and dried off, in order to prevent adhesion of the layers or inhomogeneous droplet formation. The drying off of the impregnation and the absorption by the inner layer are problematic, especially in the case of tubular casings, since they form a continuous system in combination with barrier layers, which hinders the drying process. It is also known that liquid smoke aromas and dyes can be added directly to the filling, which can lead, however, to insufficient coloring on the outside of the sausage.

DE 10344867 A1 describes a multilayer structure in which the inner layer has a surface tension of at least 28 dyn/cm2 and does not contain any browning agent. In addition, if appropriate by means of a corona discharge, the surface tension and hence the adhesion capacity of the inner layer can be modified. However, this process is technically complex and increases the risk of sticking of the inner layer as a result of the corona treatment.

DE 10244088 describes a barrier casing which, by virtue of the addition of at least one organic filler in the inner layer, which comprises food additives, can transfer these stored food additives as the filling is scalded. As a result of the organic filler, however, a support material with low melting point has to be used. This is preferably a matrix composed of an ethylene/vinyl acetate copolymer (EVA). No statements are made regarding sausage meat adhesion. The use of ethylene/vinyl acetate copolymers in direct contact with foods with a fat content is strictly regulated and thus has limits in relation to conformity with the legal requirements. In addition, these materials are very flexible, which lowers the mechanical stability. In combination with thermoplastics, which possess a significantly higher melting point than the EVA matrix with organic filler, a specific coextrusion tool is needed, which ensures a thermal separation of the individual melt layers. If this is absent, the organic substances can be damaged thermally, which can lead to burning.

EP 1439756 B1 uses, to enhance the absorptivity, a mixture of thermoplastic starch and/or thermoplastic starch derivatives and a further homo- or copolymer with hydroxycarboxylic acid units. The combination of the polymers used should have a sufficient sausage meat adhesion. The absorptive layer is on the outside at first, and the casing must be reversed in a complicated step after the application of liquid smoke. The film may have a multilayer configuration and contain barrier layers. Preference is given to producing the film in unoriented form, which, however, lowers the mechanical strength and the sufficient shrinkability, which is required for a crease-free casing.

U.S. Pat. No. 6,589,615 B1 describes another approach. Porosity modifiers such as glycerol, soybean oil and others are introduced into the inner layer, and are embedded with the aid of compounding technology into a matrix of polyamide or polyolefin. The casings described may have a one-layer or multilayer configuration and be finished with or without aromas and dyes. During the extrusion process, the porosity modifiers ensure a phase separation of the melt compound, which leads to a network of cavities connected to one another. These cavities can be filled with liquid additives in a further step. The porosity is achieved here through the particular proportion of the porosity modifier. However, these cavities also allow an increased permeability for water vapor and oxygen. When the permeability for water vapor is minimized by means of a barrier layer, the permeability for oxygen and aromas is still preserved.

The prior art casings described here have, based on the profile of requirements described above, defects in individual points. Especially the requirements for a sticking-free seamless casing with homogeneous distribution of the impregnation and sufficient sausage meat adhesion are not reconcilable by the known casings on the market. Moreover, they are often complicated to produce or do not possess sufficient absorptivity of the inner layer. Surprisingly, the shortcomings from the prior art can be alleviated with the present invention.

### SUMMARY OF THE INVENTION

The lack of film composites describes thus also gave rise to the requirement to find a structure for a synthetic food casing which firstly has an absorptive inner layer and secondly prevents weight and aroma loss. Moreover, this casing should have very good transfer properties to the filling of smoke color and smoke flavor, and also sufficient sausage meat adhesion, without influencing the peeling properties through troublesome seal seams or particularly thick-wall casing structures.

It was therefore an object of the present invention to provide a sticking-free seamless food casing with homogeneous distribution of the impregnation and sufficient sausage meat adhesion, avoiding troublesome fat and jelly separation, and the casing additionally not being complicated to produce and possessing a sufficient liquid absorption capacity of the inner layer, and preventing weight and aroma loss of the filling. In addition, it was an object of the present invention to find a liquid smoke composition which, in combination with the inventive casing, meets the abovementioned requirements with regard to sausage meat adhesion and very good transfer properties of smoke color and smoke flavor to the filling in an exceptional manner.

The stated object is now achieved by a multilayer seamless tubular film as a food casing with barrier action for oxygen and/or water vapor, which is capable of absorbing and storing a food additive and releasing it to the food, comprising:

a) an outer layer composed of a thermoplastic polymer in a layer thickness of 3 to 35 μm,
b) one or more middle functional layers with barrier action for oxygen and/or water vapor, composed of thermoplastic polymer,
c) at least one porous inner layer composed of a thermoplastic polymer in a layer thickness of 5 to 40 μm,

i) the inner layer having a network, which brings about the porosity, of spaces connected to one another, which are formed in the course of production of the tubular film with the aid of a porosity modifier, specifically in such a way that the porosity modifier is added before the coextrusion to the thermoplastic polymer for the inner layer and, after the coextrusion, a phase separation of the thermoplastic polymer for the inner layer and of the porosity modifier is brought about,

ii) the porous inner layer having a liquid absorption capacity based on the overall composite of the film in the range from 1 to 40% by weight, preferably from 3 to 30% by weight more preferably from 5 to 20% by weight, especially preferably from 6 to 15% by weight, and

iii) optionally, the spaces in the inner layer connected to one another at least partially storing the porosity modifier and/or a food additive.

In the case of a plurality of porous inner layers, the features of porosity, of stored porosity modifier and/or food additive and absorption capacity relate to all porous inner layers together.

### DETAILED DESCRIPTION OF THE PREFERRED EMBODIMENT

The liquid absorption capacity is defined as the amount of water which can be absorbed by the porous inner layer, based on the overall composite of the film. The method of determination is based on the weight difference measurements and is described exactly in the example section.

Performance studies have shown that the sausage skin should possess a minimum absorption capacity of 5% by weight based on the overall structure of the film, in order to be able to transfer a sufficient amount of food additive(s) to the filling.

For explanation, it should be noted that the food additive is applied to the inner layer or introduced into the inner layer in liquid form, but need not necessarily be stored there in liquid form. It is conceivable that the food additive absorbed at least partly gelates and/or solidifies as a result of various factors.

As described above, the network of spaces connected to one another, which brings about the porosity of the inner layer, is formed in the course of production of the tubular film with the aid of a porosity modifier. With regard to the abovementioned coextrusion process and the phase separation of the thermoplastic polymer for the inner layer and of the porosity modifier, reference is made to the more detailed description below of the preparation process for the inventive tubular film.

In a preferred embodiment of the invention, the tubular film has been biaxially oriented or is unoriented. Biaxial orientation is understood by those skilled in the art to mean the transverse and longitudinal orientation of the extrudate at temperatures between the glass transition temperature and melting temperature of the materials used. Biaxial stretching can be effected, for example, by means of a bubble which is filled with a gas or liquid pressure cushion and is sealed gas- or fluid-tight between two roll pairs running at different peripheral speeds. While the ratio of the different peripheral roll speeds corresponds to the degree of longitudinal stretching, the degree of transverse stretching is calculated from the ratio of the tube diameter in the stretched state to that in the unstretched state. The degree of areal stretching results from the product of the degree of longitudinal stretching multiplied by the degree of transverse stretching. A so-called unoriented film is understood by the person skilled in the art to mean the establishment of a film from the molten state. This dispenses with the subsequent orientation process from the thermoelastic state.

Seamless sausage casings have the advantage that they possess a high strength and, owing to the absent seam, have good peeling behavior. Moreover, tubular casings possess the advantage that the inner layer is not contaminated from the outside and hence constitutes a reliable solution from hygiene aspects.

The thermoplastic polymer of the outer layer and of the functional layer(s) is preferably in each case independently a polyamide- or polyolefin-based polymer. Suitable polymers for the outer layer are in principle all appropriate polymers including those listed below by way of example, and polyamides and polyolefins, some of which are described in detail. A polyamide-based polymer is preferred for the outer layer, since it firstly ensures printability and secondly mechanical stability. Moreover, polyamide, in contrast to polyolefins, possesses increased reliability against scratching.

The layer thickness of the outer layer is in the range from 3 to 35 μm. In order to achieve sufficient mechanical stability with simultaneously sufficient flexibility, the layer thickness of the outer layer in a preferred embodiment is in the range from 5 to 25 μm, further preferably in the range from 8 to 16 μm.

For the functional layer(s), in each case independently, preference is likewise given to using polyamide- or polyolefin-based polymers, but the selection of the polymer in each case depends on the desired property of the layer, i.e. whether, for example, a barrier layer especially against water vapor or a barrier layer especially against oxygen is desired.

In a preferred embodiment of the inventive tubular film,
a) the one functional layer or if appropriate at least one of the plurality of functional layers is a barrier layer against especially water vapor or especially oxygen, or
b) if appropriate one of the plurality of functional layers is a barrier layer especially against water vapor and a further functional layer is a barrier layer especially against oxygen,
   and each of the barrier layers especially against water vapor or especially against oxygen independently has a layer thickness of 1 to 35 μm.

For one of the desired applications of the tubular film as a casing for scalded emulsion sausage and cooked meat sausage, good barrier properties with regard to oxygen and water vapor permeation are desirable. The oxygen barrier prevents premature graying of the sausage meat facing the inside of the film. The water vapor barrier reduces the weight loss of the saleable product which is induced by evaporation of water out of the filling, and firstly reduces the revenue of the product and secondly, owing to loss of volume, can lead to creased unappealing products.

The barrier layer especially against water vapor of the inventive tubular film is preferably a polyolefin-based polymer, including homo- or copolymers with ethylene, propylene, butylene and/or straight-chain olefin units having 2 to 8 carbon atoms, or mixtures of these homopolymers and/or copolymers with one another.

The further functional layers in the multilayer embodiments may consist of substantially any materials. Preference may be given to using layers based on polyolefin, especially polyethylene, polypropylene, polybutylene, LDPE, LLDPE (linear low-density polyethylene). Also suitable are metallocene polyolefins. These are polyolefins which have been prepared with the aid of metallocene catalysts and have advantages with respect to conventionally prepared polyolefins. For example, they exhibit higher puncture resistances or else more favorable barrier properties. An overview over metallocene polyolefins is given by Böhn and Fleissner in Kunststoffe 88 (1998) p. 1864-1870, Carl Hanser Verlag, Munich.

The barrier layer especially against oxygen of the inventive tubular film is preferably a polyamide-based polymer or EVOH or a polymer blend comprising one or more of these polymers.

The polymer blends used in the context of the present invention are polymer mixtures composed of a polyamide-based polymer and/or EVOH and/or one or more further polymers, especially polyolefins.

The polyamide-based polymers used may be aliphatic or partly aromatic polyamides or copolyamides. The aliphatic polyamides and copolyamides include homopolyamides and copolyamides of aliphatic primary diamines and aliphatic dicarboxylic acids, and homopolymers and copolymers of co-aminocarboxylic acids or lactams thereof.

The aforementioned aliphatic primary diamines contain preferably 4 to 8 carbon atoms. Suitable diamines are, for example, tetra-, penta-, hexa- and octamethylenediamine; particular preference is given to hexamethylenediamine.

The aliphatic dicarboxylic acids contain preferably 4 to 12 carbon atoms. Examples of such suitable dicarboxylic acids are adipic acid, azeleic acid, sebacic acid and dodecanedicarboxylic acid.

The ω-aminocarboxylic acids or lactams thereof contain preferably 6 to 12 carbon atoms. One example of an ω-aminocarboxylic acid is 11-aminoundecanoic acid. Examples of lactams are ε-caprolactam and ω-laurolactam.

Particularly preferred aliphatic polyamides are polycaprolactam (PA 6) and polyhexamethyleneadipamide (PA66). A preferred aliphatic copolyamide is PA 6/66, which consists of caprolactam, hexamethylenediamine and adipic acid units.

The partly aromatic polyamides and copolyamides are based on the aforementioned aliphatic polyamides and copolyamides, especially the aliphatic diamines and/or dicarboxylic acids, in which case aromatic groups can be incorporated both through aromatic diamines and aromatic carboxylic acids. Examples of suitable aromatic diamines are m-xylenediamine and phenylenediamine. Examples of suitable aromatic dicarboxylic acids are isophthalic acid and terephthalic acid.

A preferred partly aromatic copolyamide contains units derived from m-xylenediamine and adipic acid. Such a polyamide (PA-MXD6) is sold, for example, by Mitsubishi Gas Chemical Company Inc., Tokyo, Japan, under the name MX-Nylon. When PA-MXD6 is used as a constituent of a polymer blend based on two or more different polyamides or copolyamides, it is preferably used in amounts of 5 to 40% by weight per layer, more preferably 10 to 30% by weight.

A likewise preferred partly aromatic copolyamide has structures derived from hexamethylenediamine, isophthalic acid and terephthalic acid. Such a polyamide (PA6I/6T) is sold, for example, by DuPont De Nemours, Wilmington, Del., USA, under the name Selar PA. When PA6I/6T is used as a constituent of a polymer blend based on two or more different polyamides or copolyamides, it is preferably used in amounts of 2 to 40% by weight per layer, more preferably 5 to 20% by weight.

As mentioned above, all polymers described above can also be used as a material for the outer layer.

The layer thickness of the functional layer(s), especially in the barrier layer(s) against water vapor and/or oxygen, is in the range from 1 to 35 μm. According to the polymer material used, the preferred range for the layer thickness may if anything be in the lower range, in the middle range or in the upper range. In the case of, for example, ethylene-vinyl alcohol copolymer layers (see below), which constitute an outstanding oxygen barrier, the preferred range for the layer thickness is if anything in the lower range.

Alternatively or additionally, it is possible to use, for the barrier layer against especially oxygen of the inventive tubular film, one composed of a fully hydrolyzed ethylene-vinyl alcohol copolymer (EVOH) with an ethylene content of 25 to 53% by weight, preferably of 29 to 38% by weight. In a preferred embodiment, the layer thickness is between 1 and 15 μm, in a further preferred embodiment between 2 and 8 μm, and more preferably between 3 and 6 μm.

In addition to the above-described materials for the barrier layers against especially oxygen or water vapor, the one functional layer or if appropriate one or more of the functional layers may also consist of the polymers and additives which are intended for the inner layer and have been described below, provided that the corresponding layer(s) has/have the required barrier action for oxygen and/or water vapor.

In a preferred embodiment of the inventive tubular film, the functional layer or if appropriate at least one of the plurality of functional layers is a primarily adhesion-promoting layer in a layer thickness of 1 to 15 μm. One or if appropriate more adhesion-promoting layer(s) may be used between each of these layers in the case of a layer sequence of layers which adhere poorly to one another, for example between a polyamide-based layer and a polyolefin-based layer.

The thermoplastic polymer of the adhesion-promoting layer is, like the barrier layer especially against water vapor, preferably a polyolefin-based polymer, including homo- or copolymers with ethylene, propylene and/or straight-chain alpha-olefin units having 4 to 8 carbon atoms or a mixture of these units. This results in the effect that, in the case of the layers used owing to their primarily adhesion-promoting properties, the tubular film automatically also receives water vapor barrier properties. The monomer units of the thermoplastic polymer of the adhesion-promoting layer have preferably been modified at least partly with carboxylic acid and/or carboxylate groups. Further suitable materials for the adhesive layer are especially graft polymers, for example polyolefins which have been grafted with maleic anhydride, and additionally also co- or terpolymers which, as well as ethylene and/or propylene units, also contain units with functional groups. The units with functional groups are, for example, (meth)acrylic acid, alkyl (meth)acrylates or vinyl acetate. A suitable adhesion promoter is also elastomer-modified polyethylene.

The thermoplastic polymer of the adhesion-promoting layer has preferably been modified with carboxylic acid and/or carboxylate groups such that the layer has adhesion-promoting properties with regard to one or both adjacent layers composed of polyamide-based material. The adhesion-promoting layer therefore preferably contains, as well as the units deriving from the aforementioned monomers, also those which are obtained through copolymerization of α,β-unsaturated mono- or dicarboxylic acids, such as acrylic acid, methacrylic acid, maleic acid, fumaric acid, itaconic acid, or the acid anhydrides, acid esters, acid amides or acid imides thereof.

The layer thickness of the adhesion-promoting layer is, as mentioned, preferably in the range from 1 to 15 μm. Further preference is given to the range from 1 to 10 μm and particular preference to that from 1 to 6 μm.

In a preferred embodiment of the inventive tubular film, the thermoplastic polymer of the inner layer is a polyamide-, polyolefin- or polyester-based polymer, including polyethylene, polypropylene, polyvinylidene chloride, polyamide, polystyrene, polyethylene terephthalate, polyvinyl polymer, ethylene-vinyl polymer, polycarbonate or polybutene.

With regard to the layer thickness of the inner layer, it has been observed that, when the preparation process described below is employed, it is possible to obtain a tubular casing which has a sufficient porosity and, associated with this, a sufficient absorptivity even from a layer thickness of at least 5 μm. Especially with the inventive liquid smoke composition described below in detail, it is possible to achieve a very good flavor transfer even in the case of a thin inner layer. Relatively thin layers, however, exhibit barely any effect and therefore generally have only an insufficient absorptivity for liquid additives, as has been shown by the results of the water absorptivity and images of the structure of the inner layer. however, preference is given to a layer thickness for the inner layer in the range from 10 to 30 μm, more preferably from 15 to 20 μm.

It was thus surprising that, with the inventive casing, a layer thickness of 10 to 20 μm for the porous inner layer may already be sufficient to accommodate such an amount of aromas and/or dyes in the layer that a sufficient color and flavoring transfer is enabled. This is surprising because, in the case of synthetic sausage casings produced to date, a significantly thicker absorptive inner layer had to be used, as described, for example, in DE 19846305 A1.

The porosity modifier of the inventive tubular film is preferably selected from the group comprising soybean oils, peanut oils, corn oils, glycerols, sorbitols, polyethylene glycols, mineral oils or surfactants, including polysorbates, polyoxythylene (POE) 20, sorbitan monostearates, sorbitan monolaurates, sorbitan monooleates, glyceryl monooleates and Surfactol 365. It is also possible to use mixtures of porosity modifiers for the inventive tubular film.

The amount of the porosity modifiers in the casing is 1 to 70% by weight, based on the total weight of the casing, preferably 10 to 40% by weight. The porosity modifiers have a density within a range from about 0.8 to 1.3 g/cm³.

The food additive of the inventive tubular film is preferably selected from the group of the aromas and flavorings, including liquid smoke, vanilla extract, annatto extract, food spices, other food aromas and fragrance extracts or mixtures of the aforementioned substances. The amount of the aromas and/or flavorings in the casing may be 1 to 60% by weight, preferably 1 to 40% by weight, based on the total weight of the casing.

The food additives added to the inventive casing may also or additionally be dyes. The dye may be selected from the group comprising caramel, brown sugar and other food dyes. The amount of the dye in the casing may be 1 to 80% by weight, preferably 1 to 60%, based on the total weight of the casing.

Since the barrier layers against especially oxygen described also possess aroma barrier properties, it may also be possible to transfer a sufficient smoke flavor with relatively small added amounts of liquid additive. Existing multilayer structures often exhibited an insufficient barrier to prevent the migration of the aromas out of the casing.

In a preferred embodiment of the inventive tubular film, the porous inner layer comprises an inorganic filler which is selected from silicon dioxide, talc (Mg₂SiO₄), aluminum oxide, aluminum hydroxide, hydrated alumina, calcined alumina, titanium dioxide, zirconium oxide, sodium silicate and silicate. The amount of the inorganic filler in the food casing may be 0 to 40% by weight, preferably 0 up to 30% by weight, based on the total weight of casing. The inorganic filler preferably has a particle size of 1 to 25 μm, further preferably of 2 to 10 μm, and preferably a density of 1.2 to 5.7 g/cm³, more preferably of 2.0 to 2.7 g/cm³.

In addition, all layers may optionally include additives such as lubricants, antiblocking agents, nucleating agents, fillers, color pigments and/or other additives.

The total layer thickness of the tubular film is preferably 25 to 100 μm, further preferably 30 to 60 μm. The individual layer thicknesses as described in the examples were determined by means of a so-called thin section image. First, a thin section of the film cross section is prepared (from Reichert/Junge, type 2035). Using a microscope image (from Leitz/Wetzler Ortholux IIPOL-MK), the individual layer thicknesses are subsequently determined by means of a digitalized image.

In a preferred embodiment of the invention, the H₂O permeability of the overall tubular film is not more than 20 g/m².d, preferably not more than 15 g/m².d, more preferably not more than 10 g/m².d, most preferably not more than 5 g/m².d, and/or the O₂ permeability of the overall tubular film is not more than 40 cm³/m².d.bar, preferably not more than 30 cm³/m².d.bar, more preferably not more than 20 cm³/m².d.bar, most preferably not more than 10 cm³/m².d.bar. The particular method of determination is specified in the example section.

The casings have a free shrinkage in at least one orientation direction, measured at 100° C. after 15 min, between 5 and 35%, preferably between 10 and 25%, more preferably between 12 and 18%. Below 40° C., the free shrinkage is less than 10%, preferably less than 6%, such that a sufficient storage stability of the heatset casings is ensured. The shrinkage is measured by the test method described further down in the examples.

The inventive casing has, especially in the case of combination of good oxygen barrier, which minimizes aroma losses, and barrier against water vapor, which reduces weight losses, great advantages over similar casings from the prior art.

The inventive casing surprisingly also has increased sausage meat adhesion when no liquid has been applied. This is especially advantageous when foods with a high water content (ham sausage, etc.) are produced, since the high water content gives rise to the risk of jelly material settling out between sausage surface and the inside of the casing. The absorptive inner layer can alleviate this problem and simultaneously increases the sausage meat adhesion.

The inventive tubular film is produced by means of coextrusion processes known per se. In short, this can be done as follows: the raw materials present in fiber, granular and/or pulverulent form, i.e. the thermoplastic polymers described above, which are intended for the particular layers, are compressed for this purpose separately from one another in a coextruder, melted, homogenized and then discharged together through a coextrusion nozzle and shaped to a seamless multilayer tube, preferably by the known “double-bubble”, as described in detail in Savic, Z.: Sausage Casings, VICTUS Lebensmittelindustriebedarf, Vienna, Austria, p. 264 ff. In the case of production by this process, the multilayer primary tube which emerges in molten form is first converted to the solid state by means of intensive air or water cooling. This is followed by heating to a temperature between the glass transition temperature and melting temperature of the polymers used, which is required for the biaxial stretching of the multilayer tube. The primary bubble is oriented by means of an applied internal pressure which is established between two roll pairs in series. For the controlled establishment of the shrinkage properties, the multilayer casing can subsequently be subjected to a heat treatment.

The present invention thus also provides a process for producing an inventive tubular film as described here, comprising the steps of:
a) providing the thermoplastic polymers intended for the particular layers, preferably in fiber, granule and/or powder form;
b) melting and homogenizing the thermoplastic polymers intended for the particular layers separately from one another;
c) coextruding the thermoplastic polymers intended for the particular layers through a coextrusion die to form a seamless multilayer tube;
d) converting the coextruded multilayer primary tube to the solid state, preferably by means of intensive air or water cooling;
e) heating the primary tube to a temperature between the glass transition temperature and melting temperature of the thermoplastic polymers used, glass transition temperature and melting temperature being determined by means of DSC to DIN 53765;
f) biaxially orienting the heated primary tube by means of an applied internal pressure which is established between two roll pairs in series; and
g) optionally adjusting the shrinkage properties by heating the stretched tubular film;
   wherein a porosity modifier and optionally an inorganic filler are added before the coextrusion to the thermoplastic polymer for the inner layer and, after the coextrusion, the conversion of the coextruded multilayer primary tube to the solid state brings about a phase separation of the thermoplastic polymer for the inner layer and of the porosity modifier.

In the above-described process, the polymer for the outer layer, the polymer for the functional layer(s), the polymer for the barrier layer especially against water vapor, the polymer for the barrier layer especially against oxygen, the polymer for the adhesion-promoting layer, the polymer for the inner layer, the porosity modifier and/or the inorganic filler for the porous inner layer can be selected as described above for the inventive tubular films.

In an additional finishing step on a moistening machine, the liquid smoke can be transferred to the casing by means of a stationary liquid bubble. For this purpose, the tubular casing is unwound from the roll, passes through two roll pairs and is rewound. The amount of liquid smoke to be applied can be controlled via the hardness and the surface configuration of the upper roll pairs, via the squeezing pressure or linear pressure of the rolls with respect to one another, via the speed of passage, via the sheet tension during the step, and also via the viscosity of the smoke concentrate, as described in DE 10124581 A1.

In addition, the application of the smoke concentrate can also take place during the shirring process. The application of liquids during the shirring process is described in DE 42 16 401. In this embodiment, the smoke concentrate, in the course of the shirring operation, is transferred via appropriate lines through the shirred tube on the inside of the sausage skin. The amount of smoke concentrate can be controlled via the liquid pressure in the spraying step, the selection of the nozzle size and the shrinkage rate in the shirring step. What is crucial for the homogeneous application is the switching on and off of the pump in the course of the intermittent shirring process.

The present invention further provides a food additive, especially an acidic liquid smoke composition, which contains, in addition to the customary ingredients of such a liquid smoke composition, 2 to 25% by weight, preferably 4 to 20% by weight, more preferably 6 to 15% by weight, of a sorbitan compound which is selected from the group comprising sorbitan monolaurate (e.g. Span 20), sorbitan monopalmitate (e.g. Span 40), sorbitan monostearate (e.g. Span 60) and sorbitan monooleate (e.g. Span 80). The customary ingredients of such an acidic liquid smoke composition include 2 to 20% by weight, preferably 5 to 15% by weight, more preferably 8 to 12% by weight, of total acid; and/or 15 to 50 mg/ml, preferably 22 to 42 mg/ml, more preferably 30 to 35 mg/ml; and/or 35 to 60% by weight, preferably 40 to 55% by weight, more preferably 45 to 50% by weight of carbonyl; and/or a Brix value of 45 to 80° Brix, preferably 58 to 72° Brix, more preferably 60 to 65° Brix.

The carbonyls, phenols and acids present in the liquid smoke products are determined by methods known to those skilled in the art: the total acid value, for instance, is measured by potentiometric acid titration by means of NaOH. The phenol content is determined by means of a modified Gibbs method designated QP-09.110 from May 1994, and the carbonyl content by means of a modified Lappan-Clark method designated QP-09.100, also from May 1994.

The present invention also provides a multilayer seamless tubular film as a food casing with barrier action for oxygen and/or water vapor, especially as described herein, wherein the tubular film comprises the above-described food additive which can be released to the food.

The inventive tubular films, especially in combination with the inventive liquid smoke composition, are outstandingly suitable as a food casing, for example, for packaging sausage, animal feed, cheese, dough materials and other pasty or liquid goods.

### EXAMPLES

### Determination of Liquid Absorptivity

First, the inner layer of a 10×10 cm sample is exposed to deionized water at 20° C. for 10 min. Subsequently, excess water is removed with an absorptive cloth, so as to obtain a dry surface. After a weight measurement on a laboratory balance (from Mettler, PM 400), the sample is heated at 80° C. in a climate-controlled cabinet for one hour (from Heraeus, B6), which completely dries off the sausage skin. The second weight measurement then provides the difference from the first measurement. The weight difference in percent based on the dry sample corresponds to the absorptivity of the inner layer.

Determination of the Permeabilities with Respect to Water Vapor and Oxygen

Oxygen permeability in cm³/m².d.bar measured at 23° C. and 75% relative humidity to DIN 53 380; water vapor permeability in g/m².d measured at 23° C. and 85% relative humidity to DIN 53 122.

### Determination of Shrinkage

Shrinkage is understood to mean the unhindered, i.e. tensionless, thermal shrinkage of the seamless tubular casing. The longitudinal shrinkage and transverse shrinkage are determined. For the measurement of longitudinal shrinkage, film strips are cut out of the seamless tubular casing of 15 mm (in transverse direction)×100 mm (in longitudinal direction). For the measurement of transverse shrinkage, film strips of 15 (in longitudinal direction)×50 mm (in transverse direction) are cut out. Subsequently, the samples are boiled in tap water for 15 min. After the boiling, the shrunk strips are taken out of the bath with tweezers and measured with a ruler. The measurements are reported in percent as the length loss of the original measured length. The mean is formed from 5 measurements in each case. The accuracy of the measurement is approx. ±1%.

Glass transition temperature and melting temperature are determined by means of DSC (differential scanning calorimetry) to DIN 53765
The following tests were carried out on the boiled and cooled sausage:

### 1. The Opening Behavior of the Sausage Skins When Deshirred on the Filling Tube is Assessed

Especially in the case of unfavorable conditions between the smoke concentrate and the absorption capacity of the sausage skin, films stick on the inside. Sticking of the film inside leads to the failure of the film. If the sausage skin can be deshirred from the filling tube without any noise, the mark of 1 can be used. When straightening causes the film to tear and hence the tubular casing to be destroyed, the mark of 6 is given.

### 2. Assessment of the Homogeneity of the Coloring

Here, the sausage surface which, in contact with the tubular casing, was contacted with smoke concentrate is assessed. More particularly, the homogeneity of the desired coloring is assessed. A homogeneous distribution means no concentration of dark or light spots on the sausage meat. In the case of very good homogeneity, the mark of 1 is given, and an inhomogeneous distribution is rated with a mark of 6.

### 3. Assessment of Dye Transfer to the Sausage Meat

The assessment takes place after the sausage casing has been pulled off. In the case of a significantly darker hue as a result of the smoke concentrate, the mark of 1 is given, and, when the sausage meat color has not changed with the smoke concentrate, the mark of 6 is given. In the case of a significantly altered hue of the sausage material compared to the zero sample, which has been produced without smoke concentrate and without smoking, the mark of 1 is given, and, when the sausage meat color has not changed with the smoke concentrate and hence possesses the same appearance as the zero sample, the mark of 6 is given.

4. Assessment of Occurrence of Jelly after the Boiling Operation

When no jelly is discernible after the sausage casing has been pulled off from the sausage meat, the mark of 1 is given. When the surface of the sausage is completely covered with jelly, it receives the mark of 6. The other marks describe the intermediate steps in the graduations.

### 5. Assessment of Taste of the First Layer

The assessment takes place after the sausage casing has been pulled off. Since the sausage meat has come into contact with the smoke concentration only in a limited layer thickness, it is also only the edge layer below the tubular casing that is tested by a team of trained testers. As a result of the extreme differences in the test specimens, a clear graduation can be made. The zero sample consists of sausage meat which has been produced without smoke concentrate.

### 6. Assessment of the Peeling Behavior

What was assessed was how easily the casing could be peeled off after cutting and how good the peeling behavior (e.g. change of direction in the course of peeling) was (marks ranging from 1=excellent to 6=poor).

### Materials Used and Examples of Layer Structure

PA6: Durethan B40 FA, aliphatic polyamide, Lanxess, Leverkusen, Germany
EVOH: EVAL® 171 B, ethylene-vinyl alcohol copolymer, Mitsui & Co. Deutschland GmbH, Dusseldorf, Germany
CoPA: Ultramid C33 LN, aliphatic copolyamide based on Polyamide 6 and Polyamide 66, BASF Ag, Ludwigshafen, Germany
HV2: Tymor® 1228 B, modified polyolefin based on maleic anhydride-grafted LLDPE, Rohm & Haas, Woodstock, Ill., USA
PAX: F09 kp PA compound, APorous Ltd., USA

### Layer Structure for Example 1:

| | | |
|---|---|---|
| Layer A: (outer layer) | PA6 | 15 μm |
| Layer B1: | EVOH | 3 μm |
| Layer B2: | PA6 | 6 μm |
| Layer C: | HV2 | 5 μm |
| Layer D: (inner layer) | PAX | 15 μm |

### Layer Structure for Example 2:

| | | |
|---|---|---|
| Layer A: (outer layer) | PA6 | 10 μm |
| Layer B1: | PA6/66 | 9 μm |
| Layer B2: | PA6 | 6 μm |
| Layer C: | HV2 | 5 μm |
| Layer D: (inner layer) | PAX | 15 μm |

### Layer Structure for Comparative Example 1:

| | | |
|---|---|---|
| Layer A: (outer layer) | PA6 | 8 μm |
| Layer B: | HV2 | 5 μm |
| Layer C: (inner layer) | PA6 + PA6/66 | 30 μm |

### Layer Structure for Comparative Example 2: Monofilm

| | | |
|---|---|---|
| Layer A: | PA6 + PA6/66 | 30 μm |

### Water Vapor Permeability Tests

TABLE 1
Results of the water vapor permeability (DIN
53122, 23° C./85% relative humidity)

| | Layer structure | Sample 1 | Sample 2 | MW |
|---|---|---|---|---|
| Test | according to | [g/m² · d] | [g/m² · d] | [g/m² · d] |
| No. 1.1 | Ex. 1 | 3.29 | 3.29 | 3.29 |
| No. 1.2 | Ex. 2 | 8.44 | 8.34 | 8.39 |
| No. 1.3 | Comp. 1 | 7.15 | 7.30 | 7.23 |
| No. 1.4 | Comp. 2 | 36.85 | 36.85 | 36.85 |

### Oxygen Permeability Tests

TABLE 2
Results of the oxygen permeability (DIN 53 380 23° C./85% r.h.)

| | Layer structure | Sample 1 | Sample 2 | MW |
|---|---|---|---|---|
| Test | according to | [cm³/m² · d] | [g/m² · d] | [g/m² · d] |
| No. 2.1 | Ex. 1 | 3.67 | 3.27 | 3.47 |
| No. 2.2 | Ex. 2 | 28.10 | 29.30 | 28.70 |
| No. 2.3 | Comp. 1 | 22.82 | 23.67 | 23.25 |
| No. 2.4 | Comp. 2 | 23.72 | 22.86 | 22.79 |

### Water Absorptivity Tests

TABLE 3
Results of the water absorptivity

| | | | | | | 60 min |
|---|---|---|---|---|---|---|
| | | | | | | drying 80° C. |
| | Layer | Thickness | Step 1 | Step 2 | 10 min water | Total weight |
| | structure | of the | Weight [g] | Weight | exposure | increase of the |
| Test | according to | inner layer | moist-ened | [g] dry | Difference [g] | inner layer [%] |
| No. 3.1 | Ex. 1 | 6 μm | 0.728 | 0.69 | 0.038 | 5.1 |
| No. 3.2 | Ex. 1 | 6 μm | 0.853 | 0.81 | 0.043 | 5.3 |
| No. 3.3 | Ex. 1 | 6 μm | 0.75 | 0.708 | 0.042 | 5.6 |
| No. 3.4 | Ex. 1 | 10 μm | 0.81 | 0.749 | 0.061 | 8.1 |
| No. 3.5 | Ex. 1 | 10 μm | 0.946 | 0.881 | 0.065 | 7.4 |
| No. 3.6 | Ex. 1 | 10 μm | 0.876 | 0.807 | 0.069 | 7.8 |
| No. 3.7 | Ex. 1 | 15 μm | 0.985 | 0.877 | 0.108 | 11 |
| No. 3.8 | Ex. 1 | 15 μm | 0.824 | 0.757 | 0.089 | 8.85 |
| No. 3.9 | Ex. 1 | 15 μm | 0.884 | 0.814 | 0.06 | 7.28 |
| No. 3.10 | Comp. 1 | 30 μm | 0.684 | 0.659 | 0.025 | 3.65 |
| No. 3.11 | Comp. 1 | 30 μm | 0.824 | 0.797 | 0.027 | 3.39 |
| No. 3.12 | Comp. 1 | 30 μm | 0.757 | 0.73 | 0.027 | 3.69 |

The results of the water absorptivity exhibited the best absorptivity at a layer thickness of the inner layer of 15 μm.

### Liquid Smoke Tests

For the following liquid smoke tests, a standard liquid smoke composition (RA JOS 01-007 M) from Red Arrow was used. The composition has a total acid content of approx. 10% by weight, a smoke aroma content of approx. 33 mg/ml, a carbonyl content of approx. 48% by weight, a Brix value of approx. 60 to 65° Brix, and also, as further components, sorbates, polysorbates and paraffin oil. The Brix value is a measure of the soluble dry substance in a liquid. Definition: a liquid has one degree Brix (=1% Brix) when it has the same density as a solution of 1 g of sucrose in 100 g of sucrose/water solution; it has 10° Brix (=10% Brix) when its density is that of a solution of 10 g of sucrose in 100 g of sucrose/water solution (corresponds to a ten percent solution).

To determine the optimal liquid smoke composition, the following mixtures from table 4.1 were contacted with an added amount of 6 g/m² on the inside of the inventive example 1. The results of the performance test are shown in table 4.2.

TABLE 4.1
Liquid smoke tests

| | Layer | | | | |
|---|---|---|---|---|---|
| | structure | | | | |
| | according | JOS 01-007 | Span | Tween | |
| Test | to | M | 40¹⁾ | 80²⁾ | Paraffin oil |
| No. 4.1 | Ex. 1 | 100 | | | |
| No. 4.2 | Ex. 1 | 90 | 10 | | |
| No. 4.3 | Ex. 1 | 85 | 10 | | 5 |
| No. 4.4 | Ex. 1 | none | none | none | none |
| (comp.) | | | | | |
| No. 4.5 | Ex. 1 | 90 | | 10 | |
| (comp.) | | | | | |

¹⁾sorbitan monopalmitate;
²⁾polyoxyethylene (20) sorbitan monooleate

### Performance Studies

The performance studies are evaluated in terms of the smoke color/flavor: 1=very good (strong flavor or color transfer) to 6=inadequate (no flavor or color transfer).

TABLE 4.2
Evaluation of the performance studies

| | Opening behavior | | | | |
|---|---|---|---|---|---|
| | of the sausage | Homogeneity | Color depth | | Taste |
| | skin on deshirring | of the coloring | after peeling | Jelly formation | assessment |
| | on the | after the peeling | off the tubular | below the | of the first |
| Test | filling tube | of the sausage | casing | tubular casing | layer |
| No. 4.1 | 5 | 3 | 1 | 1 | 1 |
| No. 4.2 | 2 | 1 | 1 | 1 | 1 |
| No. 4.3 | 1 | 1 | 1 | 1 | 1.5 |
| No. 4.4 | 1 | n/a | n/a | 1 | n/a |
| (comp.) | | | | | |
| No. 4.5 | 1 | 1 | 1 | 5 | 1 |
| (comp.) | | | | | |

After a wait time of approx. 5 days, the sausage skin types were shirred and, in the course of shirring, made ready for filling. The shirred sticks were sealed in commercial polyethylene film pouches.

The sticks were filled to nominal caliber without watering with the standard Mortadella sausage meat and treated according to a specific cooking operation. The optimal temperature profile for the transfer of color and smoke flavor was found to be one which is stopped at approx. 50° C. in the course of heating of the cooking chamber and, after a residence time of approx. 30 minutes, warms up to end temperature. The sausage meat then remains at the end temperature until the cooking process is complete.

This was finally followed by performance assessments of the abovementioned examples with the liquid smoke composition according to test 4.3 from table 4.1.

### Assessment of the Flavor and Smoke Transfer

TABLE 5
Assessment of the flavor and smoke transfer (marks
ranging from 1 = excellent to 6 = poor)

| Layer structure | Smoke | | Smoke | |
|---|---|---|---|---|
| according to | color | | flavor | |
| example | mark | Comment | mark | Comment |
| Ex. 1 | 1.5 | homogeneous | 1.5 | intense |
| Ex. 2 | 2 | homogeneous | 2 | intense |
| Comp. 1 | 4 | spotty | 5 | barely |
| | | | | perceptible |
| Comp. 2 | 4 | spotty | 3 | barely |
| | | | | perceptible |

### Tests of Peeling Behavior and Sausage Meat Adhesion

TABLE 6
Peeling test and sausage meat adhesion results

| Layer structure | | | |
|---|---|---|---|
| according to | | Sausage meat | |
| example | Peeling test | adhesion | Jelly separation |
| Ex. 1 | 1 | 1 | 0 |
| Ex. 2 | 2 | 1.5 | 0 |
| Comp. 1 | 2 | 0 | 5 |
| Comp. 2 | 3 | 0 | 4 |

1 = very good = the sausage skin can be peeled impeccably in any direction
6 = inadequate = the sausage skin does not follow the peeling direction

The evaluation of the studies performed has shown that the comparative examples provide some comparable results in the abovementioned test methods. However, the complete profile of properties as described above can be achieved only by the inventive casing.

It is understood that the examples and embodiments described herein are for illustrative purposes only and that various modifications or changes in light thereof will be suggested to persons skilled in the art and are to be included within the spirit and purview of this application and scope of any appended claims. All figures, tables, and appendices, as well as publications, patents, and patent applications, cited herein are hereby incorporated by reference in their entirety for all purposes.

What is claimed is:

1. A multilayer seamless tubular film as a food casing with barrier action for oxygen and/or water vapor, which is capable of absorbing and storing a food additive and releasing it to the food, comprising:
a) an outer layer composed of a thermoplastic polymer in a layer thickness of 3 to 35 μm,
b) one or more middle functional layers with barrier action for oxygen and/or water vapor, composed of thermoplastic polymer, and
c) a porous inner layer composed of a thermoplastic polymer in a layer thickness of 5 to 40 μm,
i) the inner layer having a network, which brings about the porosity, of spaces connected to one another, which are formed in the course of production of the tubular film with the aid of a porosity modifier, specifically in such a way that the porosity modifier is added before the coextrusion to the thermoplastic polymer for the inner layer and, after the coextrusion, a phase separation of the thermoplastic polymer for the inner layer and of the porosity modifier is brought about,
ii) the porous inner layer having a liquid absorption capacity based on the overall composite of the film in the range from 1 to 40% by weight, and
iii) optionally, the spaces in the inner layer connected to one another at least partially storing the porosity modifier and/or a food additive.

2. The tubular film as claimed in claim 1, which has been biaxially oriented or is unoriented.

3. The tubular film as claimed in claim 1, wherein the thermoplastic polymer of the outer layer and of the functional layer(s) is in each case independently a polyamide- or polyolefin-based polymer.

4. The tubular film as claimed in claim 1, wherein
a) the one or more middle functional layers is a barrier layer against water vapor or oxygen, or
b) the one or more middle functional layers is a barrier layer against water vapor and a further functional layer is a barrier layer against oxygen,
and wherein each of the barrier layers against water vapor or against oxygen independently has a layer thickness of 1 to 35 μm.

5. The tubular film as claimed in claim 4, wherein the barrier layer against water vapor is a polyolefin-based polymer, including homo- or copolymers with ethylene, propylene, butylene and/or straight-chain olefin units having 3 to 8 carbon atoms, or mixtures of these homopolymers and/or copolymers with one another.

6. The tubular film as claimed in claim 4, wherein the barrier layer against oxygen is a polyamide-based polymer or EVOH or a polymer blend comprising one or more of these polymers.

7. The tubular film as claimed in claim 1, wherein the one or more middle functional layers is a primarily adhesion-promoting layer in a layer thickness of 1 to 15 μm.

8. The tubular film as claimed in claim 6, wherein the thermoplastic polymer of the adhesion-promoting layer is a polyolefin-based polymer, including homo- or copolymers with ethylene, propylene and/or straight-chain alpha-olefin units having 3 to 8 carbon atoms, or a mixture of these units, the monomer units of the thermoplastic polymer preferably having been modified at least partly with carboxylic acid and/or carboxylate groups.

9. The tubular film as claimed in claim 1, wherein the thermoplastic polymer of the inner layer is a polyamide-, polyolefin- or polyester-based polymer selected from the group consisting of polyethylene, polypropylene, polyvinylidene chloride, polyamide, polystyrene, polyethylene terephthalate, polyvinyl polymer, ethylene-vinyl polymer, polycarbonate and polybutene.

10. The tubular film as claimed in claim 1, wherein the porosity modifier is selected from the group consisting of soybean oils, peanut oils, corn oils, glycerols, sorbitols, polyethylene glycols, mineral oils or surfactants, polysorbates, polyoxyethylene (POE) 20, sorbitan monostearates, sorbitan monolaurates, sorbitan monooleates, glyceryl monooleates, Surfactol 365, or mixtures of the aforementioned substances.

11. The tubular film as claimed in claim 1, wherein the food additive is an aroma, flavoring or fragrance selected from the group consisting of liquid smoke, vanilla extract, annatto extract, food spices, caramel, brown sugar, food dyes and mixtures of the aforementioned substances.

12. The tubular film as claimed in claim 1, wherein the porous inner layer comprises an inorganic filler which is selected from the group consisting of silicon dioxide, talc (Mg₂SiO₄), aluminum oxide, aluminum hydroxide, hydrated alumina, calcined alumina, titanium dioxide, zirconium oxide, sodium silicate and silicate.

13. The tubular film as claimed in claim 1, wherein the total layer thickness of the tubular film is 25 to 100 μm.

14. The tubular film as claimed in claim 1, wherein the H₂O permeability of the overall tubular film is not more than 20 g/m².d and/or the O₂ permeability of the overall tubular film is not more than 40 cm³/m².d.bar.

15. The tubular film as claimed in claim 1, wherein the tubular film has a shrinkage in at least one orientation direction at 100° C. after 15 min between 5 and 35%.

16. A process for producing a tubular film as claimed in claim 1 comprising the steps of
a) providing the thermoplastic polymers intended for the particular layers, preferably in fiber, granule and/or powder form;
b) melting and homogenizing the thermoplastic polymers intended for the particular layers separately from one another;
c) coextruding the thermoplastic polymers intended for the particular layers through a coextrusion die to form a seamless multilayer tube;
d) converting the coextruded multilayer primary tube to the solid state, preferably by means of intensive air or water cooling;
e) heating the primary tube to a temperature between the glass transition temperature and melting temperature of the thermoplastic polymers used, glass transition temperature and melting temperature being determined by means of DSC to DIN 53765;
f) biaxially orienting the heated primary tube by means of an applied internal pressure which is established between two roll pairs in series; and
g) optionally adjusting the shrinkage properties by heating the stretched tubular film;
wherein a porosity modifier and optionally an inorganic filler are added before the coextrusion to the thermoplastic polymer for the inner layer and, after the coextrusion, the conversion of the coextruded multilayer primary tube to the solid state brings about a phase separation of the thermoplastic polymer for the inner layer and of the porosity modifier.

17. The process as claimed in claim 16, wherein
the polymer for the outer layer is a polyamide- or polyolefin-based polymer;
the polymer for the functional layer(s) is a polyamide- or polyolefin-based polymer;
the polymer for the barrier layer against water vapor is a polyolefin-based polymer, including homo- or copolymers with ethylene, propylene, butylene and/or straight-chain olefin units having 3 to 8 carbon atoms, or mixtures of these homopolymers and/or copolymers with one another;
the polymer for the barrier layer against oxygen is a polyamide-based polymer or EVOH or a polymer blend comprising one or more of these polymers;
the polymer for the adhesion-promoting layer is a polyolefin-based polymer, including homo- or copolymers with ethylene, propylene and/or straight-chain alpha-olefin units having 3 to 8 carbon atoms, or a mixture of these units, the monomer units of the thermoplastic polymer preferably having been modified at least partly with carboxylic acid and/or carboxylate groups;
the polymer for the inner layer is a polyamide-, polyolefin- or polyester-based polymer selected from the group consisting of polyethylene, polypropylene, polyvinylidene chloride, polyamide, polystyrene, polyethylene terephthalate, polyvinyl polymer, ethylene-vinyl polymer, polycarbonate and polybutene;
the porosity modifier is selected from the group consisting of soybean oils, peanut oils, corn oils, glycerols, sorbitols, polyethylene glycols, mineral oils or surfactants, polysorbates, polyoxyethylene (POE) 20, sorbitan monostearates, sorbitan monolaurates, sorbitan monooleates, glyceryl monooleates, Surfactol 365, or mixtures of the aforementioned substances; and/or
the inorganic filler for the porous inner layer is selected from the group consisting of silicon dioxide, talc (Mg₂SiO₄), aluminum oxide, aluminum hydroxide, hydrated alumina, calcined alumina, titanium dioxide, zirconium oxide, sodium silicate and silicate.

18. A method of encasing a food comprising packaging said food in the tubular film as claimed in claim 1.

19. A food additive comprising an acidic liquid smoke composition having 2 to 25% by weight of a sorbitan compound selected from the group consisting of sorbitan monolaurate, sorbitan monopalmitate, sorbitan monostearate and sorbitan monooleate.

20. A multilayer seamless tubular film as claimed in claim 1 comprising a food additive that comprises 2 to 25% by weight of a sorbitan compound selected from the group consisting of sorbitan monolaurate, sorbitan monopalmitate, sorbitan monostearate and sorbitan monooleate, which can be released to the food.
